(19) United States
(12) Patent Application Publication
(10) Pub. No.: US 2015/0291023 A1
(43) Pub. Date: Oct. 15, 2015

(54) FUEL FILLER DEVICE

(71) Applicant: ILLINOIS TOOL WORKS INC., Glenview, IL (US)

(72) Inventors: Jean-Philippe Bar, Berneuil en Bray (FR); Matthias Kapaun, Gaukoenigshofen (DE)

(21) Appl. No.: 14/440,608

(22) PCT Filed: Nov. 15, 2013
(86) PCT No.: PCT/US2013/070407

§ 371 Date: May 5, 2015

(30) Foreign Application Priority Data
Nov. 16, 2012 (DE) 10 2012 022 394.3

(51) Int. Cl. B60K 15/05

(52) U.S. Cl. CPC B60K 15/05; B60K 2015/0474

(57) ABSTRACT

The invention relates to a fuel filler device for filling fuel into a vehicle tank, comprising a filler pipe for receiving a fuel filler nozzle, which filler pipe can be connected with the vehicle tank, wherein, in the filler pipe, a first pivotably mounted closing flap and at least a second pivotably mounted closing flap are provided behind one another as seen in the insertion direction of the fuel filler nozzle, wherein the first and at least one second closing flap can be pivoted from a closing position, closing a passage through the filler pipe, into an opening position, opening a passage through the filler pipe, by the fuel filler nozzle inserted into the filler pipe, wherein the first and at least one second closing flap are coupled with one another and/or provided such that, when the first closing flap is pivoted into its opening position, the at least one second closing flap is also pivoted at least partially into its opening position, wherein the at least one second closing flap is held in its at least partial opening position while the first closing flap is in its opening position, and wherein, when the first closing flap moves into its closing position, the at least one second closing flap also moves into its closing position.

The invention relates to a fuel filler device for filling fuel into a vehicle tank, comprising a filler pipe for receiving a fuel filler nozzle, which filler pipe can be connected with the vehicle tank, wherein, in the filler pipe, a first pivotably mounted closing flap and at least a second pivotably mounted closing flap are provided behind one another as seen in the insertion direction of the fuel filler nozzle, wherein the first and at least one second closing flap can be pivoted from a closing position, closing a passage through the filler pipe, into an opening position, opening a passage through the filler pipe, by the fuel filler nozzle inserted into the filler pipe.

In the case of so-called capless fuel filler devices (capless fuel filler systems), at least two closing flaps are pivotably mounted in a filler pipe, one behind the other as viewed in an insertion direction of a fuel filler nozzle. In the prior art, the closing flaps are in each case biased by a spring element into a closed position in which they block a passage through the filler pipe for fuel, for example. When the fuel filler nozzle is inserted, it abuts by way of its free end firstly against the first closing flap and pivots the latter counter to the spring bias into an open position in which it allows the fuel filler nozzle to pass through. Subsequently, the fuel filler nozzle abuts against the second closing flap and pushes the latter, too, counter to the spring bias into an open position in which said second closing flap also allows the fuel filler nozzle to pass through. The filling of the fuel tank with fuel can subsequently be performed via the fuel filler nozzle. After the tank filling process is complete, the fuel filler nozzle is pulled out of the filler pipe again, wherein said fuel filler nozzle initially passes out of the passage opening opened up by the second closing flap. The second closing flap thereupon moves back into the closed position owing to its spring bias. Subsequently, the fuel filler nozzle is also pulled out of the passage opened up by the first closing flap, and the first closing flap, too, moves back into its closed position owing to its spring bias.

A disadvantage of the known design is that it has a relatively complex structure owing inter alia to the spring bias that must be provided for each of the closing flaps. Furthermore, the known device takes up a considerable amount of installation space. Finally, owing to the immediate closure of the second closing flap after the fuel filler nozzle is pulled out, fuel still emerging from the fuel filler nozzle at this point in time can collect in the intermediate space between the closing flaps, which is likewise undesirable.

Taking the explained prior art as a starting point, it is the object of the invention to provide a fuel filler device of the abovementioned type which has a simple design, takes up little installation space and prevents fuel from remaining in the intermediate space between the closing flaps.

The invention achieves the object by means of the subject matter of claim 1. Advantageous embodiments are specified in the dependent claims, in the description and in the figures.

The invention achieves the object by means of a fuel filler device for filling fuel into a vehicle tank, comprising a filler pipe for receiving a fuel filler nozzle, which filler pipe can be connected with the vehicle tank, wherein, in the filler pipe, a first pivotably mounted closing flap and at least a second pivotably mounted closing flap are provided behind one another as seen in the insertion direction of the fuel filler nozzle, wherein the first and at least one second closing flap can be pivoted from a closing position, closing a passage through the filler pipe, into an opening position, opening a passage through the filler pipe, by the fuel filler nozzle inserted into the filler pipe, wherein the first and at least one second closing flap are coupled with one another and/or provided such that, when the first closing flap is pivoted into its opening position, the at least one second closing flap is also pivoted at least partially into its opening position, in particular into its opening position, wherein the at least one second closing flap is held in its at least partial opening position, in particular its opening position, while the first closing flap is in its opening position, and wherein, when the first closing flap moves into its closing position, the at least one second closing flap also moves into its closing position.

It is possible for the coupling between the closing flaps, or the arrangement according to the invention of the closing flaps, to be realized for example by virtue of the two closing flaps being arranged at a small distance one behind the other in the axial direction of the filler pipe. The first closing flap, when pivoting into its opening position, then touches the at least one second closing flap, such that the second closing flap is likewise pivoted already during the opening of the first closing flap. The at least one second closing flap then correspondingly remains in its at least partial opening position until the first closing flap moves back into its closing position. The at least one second closing flap can thereupon then also move back into its closing position. The first closing flap, when pivoting into the open position, can move through the passage which is closed by the at least one second closing flap in its closing position. In particular, the first closing flap may be smaller, for example may have a smaller diameter, than the at least one second closing flap. It is self-evident that the opening position is not imperatively a fixedly predefined position. The opening angle of the closing flaps and thus the opening position thereof are dependent, for example, on the diameter of a fuel filler nozzle that is used, or the mounting angle thereof.

For particularly well-defined coupling, it may also be provided in one embodiment that the first and the at least one second closing flap are coupled with one another by means of at least one coupling element. The coupling element is then designed such that, when the first closing flap is pivoted into its opening position, said coupling element effects an at least partial pivoting of the at least one second closing flap, too, into its opening position. Furthermore, the coupling element is designed such that it holds the at least one second closing flap in its at least partial opening position while the first closing flap is in its opening position, and such that, when the first closing flap moves into its closing position, said coupling element effects a movement of the at least one second closing flap, too, into its closing position. The coupling element may basically be of single-part or multi-part form.

The fuel filler device according to the invention is in particular a capless fuel filler device, that is to say no external closing cap is provided in addition to the closing flaps arranged in the filler pipe. The first and the at least one second closing flap are preferably coupled to one another, in particular by means of at least one coupling element. When a fuel filler nozzle is inserted into the filler pipe of the fuel filler device according to the invention, it abuts by way of its free end firstly against the first closing flap which is situated in its closed position. As the fuel filler nozzle is inserted further, the first closing flap is pivoted into its opening position by said fuel filler nozzle. By means of the coupling according to the invention or the coupling element according to the invention, said pivoting movement of the first closing flap is transmitted to the at least one second closing flap arranged behind said first closing flap as viewed in the insertion direction of the fuel filler nozzle. In particular, the coupling or the coupling element ensures that the pivoting of the first closing flap into its opening position also causes the second closing flap arranged behind said first closing flap in the filler pipe to be at least partially pivoted, specifically before the fuel filler nozzle reaches the second closing flap.

When the fuel filler nozzle reaches the passage that is closed by the second closing flap in its closing position, the second closing flap is thus already situated at least partially in its opening position, such that the fuel filler nozzle can be pushed further into the filler pipe through the now at least partially opened-up passage. If the second closing flap has been only partially pivoted into its opening position during the course of the pivoting of the first closing flap into its opening position, the second closing flap can be pivoted, in particular pushed, further into its opening position by the inserted fuel filler nozzle. It is however also possible for the second closing flap to also be pivoted fully into its opening position already during the course of the pivoting of the first closing flap into its opening position, such that the fuel filler nozzle can be pushed through the now opened-up passage of the second closing flap without further pivoting of the second closing flap.

The process of filling the vehicle tank can subsequently be performed via the fuel filler nozzle. After the end of the tank filling process, the fuel filler nozzle is, in a known way, pulled out of the filler pipe again. Owing to the coupling of the closing flaps that is effected in particular by means of the coupling element, it is achieved that the second closing flap can move back into its closing position again only when the first closing flap also moves back into its closing position. The closing process of the closing flaps thus takes place conjointly, like the opening process. The second closing flap remains at least partially in its opening position even after the fuel filler nozzle is pulled out of the passage opened up by the second closing flap, specifically until the fuel filler nozzle has also been pulled out of the passage opened up by the first closing flap, and the closing flaps move back into their closing position. It is basically also possible here for more than two closing flaps, in particular multiple second closing flaps, to be provided. In this case, respectively adjacent closing flaps are coupled in the manner according to the invention, preferably by means of at least one coupling element designed according to the invention.

Owing to the delayed closing process, according to the invention, of the at least one second closing flap, fuel still emerging from the fuel filler nozzle is reliably prevented from being able to remain in the intermediate space formed between the closing flaps. Rather, such fuel that emerges in a delayed manner can also pass to the fuel tank. The resistance of the fuel filler device to fuel is thereby improved. Furthermore, owing to the coupling, it is possible for the pivot axles for the pivotable mounting of the closing flaps to be arranged closer in the axial direction of the filler pipe, and thus for the installation space between the closing flaps to be reduced. In this way, it is also possible for the size of the fuel filler device as a whole to be reduced. Furthermore, the design of the fuel filler device according to the invention is simplified in relation to conventional systems. Owing to the possible arrangement of the closing flaps with a smaller spacing, the mounting process, and opening of the closing flaps, is improved in the case of short fuel filler nozzles, for example in the case of very short so-called Husky X filler nozzles that are used in the USA.

The fuel filler device according to the invention has a very broad range of application. It can be used for capless filler systems, filler heads, conventional fuel filler nozzle guides, systems with or without a misfuelling inhibitor, fuel filler devices that are capable of being serviced and fuel filler devices that are not capable of being serviced, etc. The fuel filler device according to the invention can basically also be used for filler pipes composed of plastic or metal.

A first spring element may be provided which biases the first closing flap into its closing position, and/or a second spring element may be provided which biases the second closing flap into its closing position. Such spring elements for providing a required biasing action may, in a manner known per se, be in the form of spiral springs or leg springs. It is basically possible for both the first and also the at least one second closing flap to be biased into its closing position by in each case one spring element. This is relevant in particular in the case of a coupling configuration without a coupling element. If the coupling according to the invention is realized by means of a coupling element, it is however also possible in a particularly advantageous manner for only one of the first and at least one second closing flaps to be biased into the closing position by a spring element. In this case, the bias of the closing flap that is biased by a spring element is utilized, via the coupling element, to indirectly also bias the other closing flap into its closing position. It is for example possible for only one spring element to be provided, such that only one closing flap is biased into the closing position by a spring element. This yields a further simplification of the design because the number of required components, in particular spring elements, can be reduced.

In a further embodiment, the first closing flap and the at least one second closing flap may be pivotably mounted on a pipe section which is inserted into the filler pipe. It is then furthermore possible for the first closing flap and the at least one second closing flap to each abut on a ring-shaped flange of the pipe section in their closing position. Furthermore, the first closing flap and the at least one second closing flap may be pivotably mounted on the ring-shaped flange. These are particularly practical configurations. Thus, a module for a capless fuel filler system is provided which, as a prefabricated assembly, can be inserted into and fastened in the filler pipe in a simple manner, for example by means of a welding process.

In one particularly practical embodiment, the coupling element may comprise a coupling bar. The coupling bar may be connected by way of its ends in a jointed, in particular pivotable, manner to a respective one of the closing flaps. This yields particularly simple coupling between the first and second closing flaps. The coupling bar is arranged between adjacent closing flaps. If more than two closing flaps are provided in the fuel filler device, it is possible for a coupling bar of said type to be provided in each case between adjacent closing flaps. Owing to the jointed connection of the coupling bar by way of its two ends to a respective one of the closing flaps, the opening and closing movements of the closing flaps are coupled to one another. When the closing flaps are situated in their closing position, the coupling bar may in particular extend in the direction of a normal with respect to those surfaces of the adjacent closing flaps which face toward one another. Here, the coupling bar may be connected by way of its ends in each case centrally to the closing flaps. The closing flaps may for example be of circular form. The coupling bar may then be connected to the closing flaps in each case at the circle central point.

It is pointed out that other coupling elements are basically also conceivable. Connecting bars, connecting pins, hinges, in particular film hinges, etc., are mentioned merely as examples.

An exemplary embodiment of the invention will be explained in more detail below on the basis of figures, in which, schematically in each case:

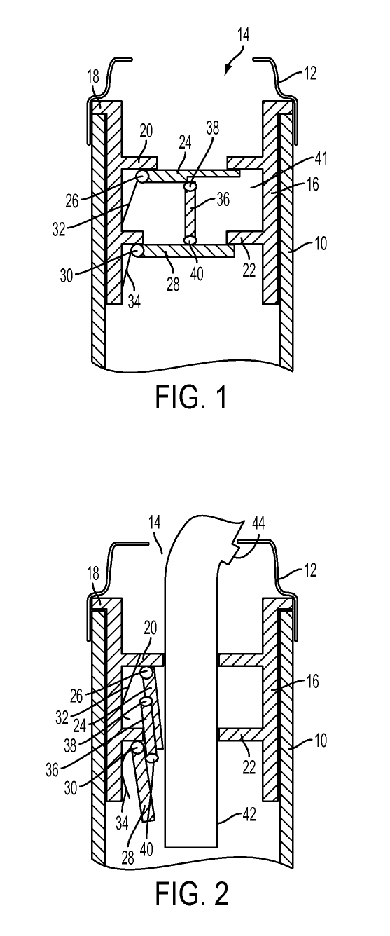

FIG. 1 shows a fuel filler device according to the invention in a sectional view with the closing flaps closed, and

FIG. 2 shows the fuel filler device shown in FIG. 1 in a sectional view with the closing flaps open.

Unless stated otherwise, the same reference signs are used to denote identical items in the figures. FIG. 1 shows a fuel filler device according to the invention for the filling of fuel into a vehicle tank (not shown) of an automobile in a first operating state. The fuel filler device comprises a filler pipe 10 which may be composed of plastic or metal. By way of its lower end which is not shown in FIG. 1, the filler pipe 10 is connected to a vehicle tank of an automobile. At its upper end in FIG. 1, there is connected to the filler pipe 10 an insertion section 12 which forms an insertion opening 14 for a fuel filler nozzle which is not shown in FIG. 1. The fuel filler device according to the invention shown in the figures forms a capless fuel filler system, that is to say no external cap is provided for closing off the insertion opening 14.

Furthermore, there is inserted into the upper end of the filler pipe 10 a pipe section 16, the latter being for example welded, or crimped or locked by way of a metal element, to the filler pipe 10. At its upper end in FIG. 1, the pipe section 16 has a flange 18 by way of which it rests on the upper end of the filler pipe 10. The pipe section 16 also has, arranged one behind the other as viewed in the insertion direction of a fuel filler nozzle, that is to say from top to bottom in FIG. 1, a first ring-shaped flange 20 extending from its inner wall and a second ring-shaped flange 22 likewise extending from its inner wall. The first ring-shaped flange 20, on its underside facing away from the insertion opening 14, has a first closing flap 24 pivotably mounted thereon by means of a pivot bearing 26. Correspondingly, the second ring-shaped flange 22, on its underside facing away from the insertion opening 14, has a second closing flap 28 pivotably mounted thereon by means of a pivot bearing 30. The first closing flap 24 is biased into its closing position shown in FIG. 1 by means of a first spring element 32. In the example shown, the second closing flap 28 is likewise biased into its closing position shown in FIG. 1, specifically by means of a second spring element 34. It is however pointed out that it is also possible for only one of the spring elements 32, 34 to be provided, such that only one of the closing flaps 24, 28 is biased into its closing position. In the closing position shown in FIG. 1, the closing flaps 24, 28 close a passage through the filler pipe 10. Here, in their closing positions, one or both of the closing flaps 24, 28 may bear sealingly against the respectively associated ring-shaped flange 20, 22. The closing flaps 24, 28 may for example be of circular form as seen in plan view.

FIG. 1 also shows a coupling element which, in the present case, comprises a coupling bar 36. The coupling bar 36 is connected by way of one end thereof in a jointed, for example pivotable, manner to the first closing flap 24, as shown at the reference sign 38. The coupling bar 36 is connected by way of its other end in a jointed manner to the second closing flap 28, as shown at the reference sign 40. In the closed position of the closing flaps 24, 28 shown in FIG. 1, the coupling bar 36 extends between the circle central points of those surfaces of the closing flaps 24, 28 which face toward one another, in the example shown in the direction of a normal with respect to said surfaces, which face toward one another, of the closing flaps 24, 28. An intermediate space 41 is formed between the closing flaps 24, 28 when these are in the closed position. The pipe section 16 with closing flaps 24, 28 pivotably mounted thereon can be inserted in a modular manner as a prefabricated assembly into the filler pipe 10.

FIG. 2 shows the closing flaps 24, 28 in their open position. In particular, in FIG. 2, the reference sign 42 indicates a fuel filler nozzle that has been inserted through the insertion opening 14 into the filler pipe 10. The fuel filler nozzle 42 has a projection 44 which serves for the mounting and hooking of the fuel filler nozzle 42 onto the insertion section 12. During the course of the insertion of the fuel filler nozzle 42 into the filler pipe 10, said fuel filler nozzle abuts, by way of its free end, firstly against the first closing flap 24 and pushes the latter in a pivoting movement from the closing position shown in FIG. 1 into the opening position shown in FIG. 2. Owing to the coupling bar 36, said opening movement is transmitted to the second closing flap 28, which is thus likewise pivoted into its opening position, without the fuel filler nozzle 42 being in contact with the second closing flap 28 for this purpose. As can be seen in FIG. 2, in said open position, the closing flaps 24, 28 including the coupling bar 36 open up the passage for the fuel filler nozzle 42. The fuel filler nozzle 42 can thus be inserted fully into the filler pipe 10, past the two annular flanges 20, 22, until the projection 44 hooks onto the insertion section 12, as can be seen in FIG. 2. The filling of the vehicle tank with fuel can now take place via the fuel filler nozzle 42 of the automobile.

When the tank filling process is complete, the fuel filler nozzle 42 is pulled out of the filler pipe 10 again, that is to say upward in FIG. 2. As is readily apparent from the figures, owing to the coupling bar 36, the second closing flap 28 remains in its opening position shown in FIG. 2 until the fuel filler nozzle 42 has been pulled out of the filler pipe 10 to such an extent that the first closing flap 24 can pivot back into its closing position. The second closing flap 28 then also closes together with the first closing flap 24, this being effected by the coupling element 36 and, if provided, the second spring element 34.

The invention firstly permits a simpler and more compact design. Furthermore, a situation is reliably prevented in which fuel that emerges in a delayed manner from the fuel filler nozzle 42 can accumulate in an undesired manner in the intermediate space 41 formed between the closing flaps 24, 28.

It is also pointed out that the fuel filler device shown in the figures may also have a misfuelling inhibitor (Misfuel Inhibitor MFI). It is also pointed out that more than the two closing flaps 24, 28 that are shown may be provided. Said closing flaps may then be connected to one another in each case by means of coupling bars. Other coupling elements are also conceivable. It is also conceivable for the coupling to be realized without a coupling element, for example by virtue of the first closing flap 24, during its opening movement, abutting against the at least one second closing flap 28. Furthermore, the filler device shown in the figures may be either capable of being serviced or not capable of being serviced.

1. Fuel filler device for filling fuel into a vehicle tank, comprising a filler pipe for receiving a fuel filler nozzle, which filler pipe can be connected with the vehicle tank, wherein in the filler pipe a first pivotably mounted closing flap and at least a second pivotably mounted closing flap are provided behind one another, seen in the insertion direction of the fuel filler nozzle, wherein the first and the at least one second closing flap can be pivoted from a closing position, closing a passage through the filler pipe, into an opening position, opening a passage through the filler pipe, by the fuel filler nozzle inserted into the filler pipe,
characterized in that wherein the first and at least one second closing flap are coupled with one another and/or provided such, that when the first closing flap is pivoted into its opening position also the at least one second closing flap is pivoted at least partially into its opening position, wherein the at least one second closing flap is held in its at least partial opening position while the first closing flap remains in its opening position, and wherein when the first closing flap moves into its closing position also the at least one second closing flap moves into its closing position.

2. Fuel filler device according to claim 1, wherein the first closing flap and the at least one second closing flap are provided with such a small distance behind one another in the axial direction of the filler pipe, that the first closing flap, when pivoting into its opening position, touches the at least one second closing flap and also pivots the at least one second closing flap at least partially into its opening position.

3. Fuel filler device according to claim 1, wherein the first closing flap when pivoting into the opening position, moves through the passage which is closed by the at least one second closing flap in its closing position.

4. Fuel filler device according to claim 1, wherein the first and the at least one second closing flap are coupled with one another through at least one coupling element, wherein the coupling element is provided such that when the first closing flap is pivoted into its opening position an at least partial pivoting also of the at least one second closing flap into its opening position is effected, and wherein the coupling element is provided such that the at least one second closing flap is held in its at least partial opening position while the first closing flap remains in its opening position, and when the first closing flap moves into its closing position also a movement of the at least one second closing flap into its closing position is effected.

5. Fuel filler device according to claim 1, wherein a first spring element is provided which biases the first closing flap into its closing position and/or that a second spring element is provided which biases the at least one second closing flap into its closing position.

6. Fuel filler device according to claim 1, wherein the first closing flap and the at least one second closing flap are pivotably mounted on a pipe section which is inserted into the filler pipe.

7. Fuel filler device according to claim 6, wherein the first closing flap and the at least one second closing flap each abut on a ring-shaped flange of the pipe section in their closing position.

8. Fuel filler device according to claim 7, wherein the first closing flap and the at least one second closing flap are pivotably mounted on the ring-shaped flange.

9. Fuel filler device according to claim 4, wherein the coupling element comprises a coupling bar.

10. Fuel filler device according to claim 9, wherein the coupling bar is connected with its ends jointed with a respective one of the closing flaps.

11. Fuel filler device according to claim 9, wherein the coupling bar is in each case connected with its ends centrally with the closing flaps.
